(19) United States
(12) Patent Application Publication
(10) Pub. No.: US 2024/0414419 A1
(43) Pub. Date: Dec. 12, 2024

(54) OPTICAL SYSTEM FOR A CAMERA AND CAMERA HAVING AN OPTICAL SYSTEM

(71) Applicant: Carl Zeiss AG, Oberkochen (DE)

(72) Inventors: Chang Liu, Aalen (DE); Johannes Zellner, Aalen (DE)

(21) Appl. No.: 18/655,181

(22) Filed: May 3, 2024

(30) Foreign Application Priority Data
May 5, 2023 (DE) 10 2023 111 846.3

(51) Int. Cl. H04N 23/23; G02B 9/04; G03B 30/00

(52) U.S. Cl. CPC H04N 23/23; G02B 9/04; G03B 30/00

(57) ABSTRACT

The disclosure relates to an optical system and to a camera having an optical system and being configured to image an object. The optical system includes a sensor unit, lens units and an immersion unit. When viewed in the light incidence direction, first the first lens unit, then the second lens unit, then the immersion unit, and then the sensor unit are arranged along an optical axis. Further, the immersion unit is arranged both at the second lens unit and at the sensor unit. The second lens unit and the immersion unit together have positive refractive power.

### CROSS REFERENCE TO RELATED APPLICATION

This application claims priority to German patent application No. 10 2023 111 846.3, filed 5 May 2023, the entire content of which is incorporated herein by reference.

### TECHNICAL FIELD

The disclosure relates to an optical system for a camera and to a camera having an optical system. The camera is arranged in particular at a portable telephone, at a portable computer, at a vehicle, in a flying object (for example a drone or a satellite), at a manned aircraft or at an unmanned aircraft.

### BACKGROUND

A known optical system in the form of a camera module, which is arranged at a portable device (for example a digital camera, a handheld computer, etc.), has a lens system, which uses a lens or several lenses to image images of an object onto a sensor unit (also referred to as image capture unit). For example, the sensor unit is configured as a charge-coupled device (CCD) or a complementary metal-oxide-semiconductor (CMOS). A camera module of this type may be arranged in a portable telephone (mobile phone). The camera module or the lenses thereof should meet numerous conditions. For example, it is particularly desirable that the camera module requires a small installation space and should be configured to be small accordingly. Further, the number of lenses used for the lens system should be as low as possible. Since these are also mass-produced items, it is also desirable that the camera module can be manufactured at low cost. In this respect, a camera module should be able to be formed with few elements, where the few elements should also be inexpensive. The camera module should also have good resolution capability.

This patent application deals with the resolution capability of an optical system, for example in the form of the aforementioned camera module. The theoretical resolution limit of an aforementioned optical system is given by the so-called Airy diameter, which is calculated as follows:

$$d = \frac{1.22 \cdot λ}{n \cdot sin θ} \qquad [ 1 ]$$

where d is the Airy diameter, λ is the wavelength of light incident into the optical system, n is the refractive index at a plane of the image of the object generated by the optical system, wherein the plane is a detection surface of a sensor unit of the optical system, and θ is half the angle of incidence of marginal rays of the light beam incident on the sensor unit of the optical system.

The variable

$$n \cdot sin θ$$

gives the numerical aperture NA of the optical system. The numerical aperture NA results from the so-called F-number (abbreviated to “f/ #”) of the optical system:

$$n \cdot sin θ = \frac{1}{2 f / \#} \qquad [ 2 ]$$

If one now takes equation [2] into consideration in equation [1], the result is

$$d = 2.44 \cdot λ \cdot f / \# \qquad [ 3 ]$$

The lower the wavelength and/or the F-number, the lower the resolution limit d is.

The prior art has described sensor units which have a plurality of pixels. Each pixel of the plurality of pixels is used to detect light incident on the pixel. Basically, a detection unit is arranged on each pixel. The detection unit detects light incident on the pixel and generates a detection signal depending on the incident light, said detection signal being passed to a processor unit, for example. The processor unit evaluates the detection signals passed to it and displays the evaluation, for example in the form of an image on a display unit. Directly adjacent pixels of the plurality of pixels have, for example, in the case of sensors for the visible wavelength range a distance from one another of 1 μm or 0.8 μm or in the case of sensors for long-wave infrared light a distance of approximately 12 μm or 17 μm, with this distance being measured from the center of a first pixel to the center of a second pixel, with the first pixel and the second pixel being directly adjacent to one another. In order to be able to resolve detection signals of two adjacent pixels of a sensor unit in an image of an object that is imaged by the optical system described above well, the resolution limit of the optical system should correspond or substantially correspond to the aforementioned distance. In order to achieve a resolution limit of a few μm, in particular less than 1 μm, it is therefore desirable to configure the optical system in such a way that its F-number is small in order to achieve a small resolution limit d.

The prior art discloses a thermal imaging camera which has an optical system having a lens system and having an electronic sensor unit. The lens system images an object onto the electronic sensor unit. The electronic sensor unit detects infrared light, for example from a wavelength range of approximately 1 μm to 15 μm. According to the so-called Rayleigh criterion, assuming that it is an aberration-free optical system, the optical resolution R of the optical system of the thermal imaging camera can be determined as follows:

$$R = 0.61 \cdot \frac{λ}{NA} \qquad [ 4 ]$$

where R is the optical resolution of the optical system of the thermal imaging camera, λ is the wavelength of light incident into the optical system, and NA is the numerical aperture of the optical system of the thermal imaging camera.

As already mentioned above, the numerical aperture NA corresponds to the variable

$$n \cdot sin θ$$

where n is the refractive index at a plane of the image of the object generated by the optical system of the thermal imaging camera, wherein the plane is a detection surface of the electronic sensor unit of the optical system, and θ is half the angle of incidence of marginal rays of the light beam incident on the electronic sensor unit of the thermal imaging camera.

The optical resolution R of the optical system of the thermal imaging camera can therefore also be determined as follows:

$$R = 0.61 \cdot \frac{λ}{n \cdot sin θ} \qquad [ 5 ]$$

The optical resolution R of the optical system of the thermal imaging camera will accordingly increase, the larger the numerical aperture NA is.

From the prior art, the method of immersion is known in light microscopy, in which an immersion fluid is introduced between a lens system and an object to be observed. In other words, the object to be observed is embedded in the immersion fluid. It is known that the resolution of an image of the object that can be achieved can be increased due to the use of the immersion fluid in light microscopy.

With regard to the prior art, reference is made to U.S. Pat. No. 3,397,314 A, US 2005/0254121 A1, U.S. Pat. Nos. 4,636,631 A, 5,623,143 A, 4,425,504 A, CN 111025529 A and CN 109061860 A.

### SUMMARY

It is an object of the disclosure to provide an optical system having a relatively low F-number in order to achieve a small resolution limit. It is also an object of the disclosure to provide an optical system having a relatively large numerical aperture NA in order to achieve a good optical resolution of the optical system. It is a further object of the disclosure to provide a camera having such an optical system.

This object is achieved by an optical system for a camera for imaging an object and a camera for imaging an object having an optical system as described herein.

The optical system according to an aspect of the disclosure is provided for a camera for imaging an object. For example, the optical system according to the disclosure and/or the camera on which the optical system according to the disclosure is arranged is/are arranged at a portable telephone, at a portable computer, at a vehicle, in a flying object (for example a drone or a satellite), at a manned aircraft or at an unmanned aircraft. Explicit reference is made to the fact that the optical system according to an aspect of the disclosure is not restricted to the aforementioned embodiments. Rather, the optical system may be arranged at any optical device for which the optical system is suitable. By way of example, the optical system may be arranged in a pair of field glasses, in a refractor, in a telescope, in a spotting scope, or in a light microscope.

The optical system according to an aspect of the disclosure has at least one sensor unit. For example, the sensor unit is configured as a cooled sensor, as an uncooled sensor, as a CCD sensor, as a CMOS sensor, as an indium gallium arsenide (InGaAs) sensor, as an indium antimonide (InSb) sensor, as an mercury cadmium telluride (MCT) sensor, as a quantum well infrared photodetector (QWIP) sensor and/or as a microbolometer. The disclosure is not restricted to the aforementioned exemplary embodiments of the sensor unit. Rather, any sensor unit suitable for the disclosure can be used as sensor unit. The sensor unit can also be referred to as an electronic sensor unit. For example, the sensor unit has a plurality of pixels. Each pixel of the plurality of pixels is used to detect light incident on the pixel. Basically, a detection unit is arranged at each pixel. The detection unit detects light incident on the pixel and generates a detection signal depending on the incident light, said detection signal being passed to a processor unit, for example. The processor unit evaluates the detection signals passed to it and displays the evaluation, for example in the form of an image on a display unit. In addition or as an alternative thereto, provision is made for the detection signal and/or the image to be stored in a storage unit. In turn, in addition or as an alternative thereto, provision is made for the detection signal and/or the image to be forwarded to another unit, for example to another computer system.

In addition, the optical system according to an aspect of the disclosure includes at least one first lens unit and at least one second lens unit. For example, the first lens unit is provided with a single lens. Further exemplary embodiments of the optical system according to the disclosure make provision for the first lens unit to include several lenses and/or several optical elements (for example in the form of a prism or a mirror). In a further exemplary embodiment of the optical system according to the disclosure, the first lens unit is formed as a lens group including several lenses and/or several optical elements. Further, provision is made, for example, for the second lens unit to be provided with a single lens. Further exemplary embodiments of the optical system according to the disclosure make provision for the second lens unit to include several lenses and/or several optical elements (for example in the form of a prism or a mirror). In a further exemplary embodiment of the optical system according to the disclosure, the second lens unit is formed as a lens group including several lenses and/or several optical elements. As an alternative, in yet another exemplary embodiment of the optical system according to the disclosure, provision is made for the optical system according to the disclosure to include at least one first lens group and at least one second lens group, each of the lens groups including several lenses and/or several optical elements.

The optical system according to an aspect of the disclosure is provided with at least one immersion unit, which, for example, has a refractive index (that is to say a refractive number) n larger than 1. In particular, the following applies to the refractive index n: 1<n≤6 or 1<n≤4. For example, the refractive index of the immersion unit is larger than a refractive index of a medium adjacent to the immersion unit at the object side. For example, the medium is air or the second lens unit. In a further exemplary embodiment of the system according to the disclosure, the refractive index of the immersion unit is very similar to or identical to the refractive index of a medium adjacent to the immersion unit at the object side. For example, the refractive index of the immersion unit and the refractive index of the medium adjacent to the immersion unit at the object side differ by ±0.01 or ±0.02.

The optical system according to an aspect of the disclosure has a light incidence direction. The light incidence direction is the direction in which light, when viewed from the object, enters the optical system according to an aspect of the disclosure and in which the light passes through the optical system according to an aspect of the disclosure until it is detected by the sensor unit. When viewed from the object in the light incidence direction, first the first lens unit, then the second lens unit, then the immersion unit and then the sensor unit are arranged along an optical axis of the optical system according to the disclosure.

The immersion unit is arranged between the second lens unit and the sensor unit. Further, the immersion unit is arranged both at the second lens unit and at the sensor unit. In contrast to the prior art, the immersion unit is not arranged at the object, but at the sensor unit on which the object is imaged with the second lens unit. By way of example, the immersion unit is in the form of a lens device. In particular, provision is made for the lens device to have a first side and a second side. The first side of the lens device is directed towards the second lens unit and is curved, for example. The second side of the lens device is directed towards the sensor unit and is planar, for example. In a further exemplary embodiment of the optical system according to the disclosure, provision is made in addition or as an alternative for the lens device to be provided with a single lens. Further exemplary embodiments of the optical system according to the disclosure make provision for the lens device to include several lenses and/or several optical elements (for example in the form of a prism or a mirror). In a further exemplary embodiment of the optical system according to the disclosure, the lens device is formed as a lens group including several lenses and/or several optical elements.

Provision is also made for the second lens unit and the immersion unit together to have positive refractive force. In this respect, the second lens unit and the immersion unit behave like a converging lens. The first lens unit, the second lens unit and the immersion unit are used to image the object onto the sensor unit.

The optical system according to an aspect of the disclosure ensures that a larger numerical aperture NA of the optical system according to the disclosure can be achieved due to the arrangement of the immersion unit at the sensor unit. A larger numerical aperture NA of the optical system according to the disclosure in contrast to the prior art leads to a smaller F-number of the optical system according to the disclosure in comparison with the prior art. It is therefore possible to achieve a smaller resolution limit compared to the prior art (see equation [3]). Due to the larger numerical aperture of the optical system according to the disclosure in comparison with the prior art, a higher resolution of the optical system according to the disclosure in comparison with the prior art can also be achieved (see equation [5]). Further, the optical system according to the disclosure ensures that the numerical aperture in the region of the sensor unit is larger than the numerical aperture in the object-side region of the immersion unit.

In one exemplary embodiment of the optical system according to the disclosure, provision is made in addition or as an alternative for the immersion unit to touch the sensor unit. In other words, the immersion unit is arranged directly at the sensor unit. In particular, provision is made for a surface of the immersion unit directed towards the sensor unit to touch a detection surface of the sensor unit directed towards the immersion unit. For example, provision is made for the immersion unit to touch the sensor unit in parts. In other words, provision is made in this exemplary embodiment of the optical system according to the disclosure for only a first part of the surface of the immersion unit directed towards the sensor unit to be directly arranged at the detection surface of the sensor unit directed towards the immersion unit. A second part of the surface of the immersion unit directed towards the sensor unit is not directly arranged at the detection surface of the sensor unit directed towards the immersion unit. The second part of the surface of the immersion unit directed towards the sensor unit is therefore arranged at a distance from the sensor unit. As an alternative thereto, provision is made for the immersion unit to touch the sensor unit in full. In other words, provision is made in this exemplary embodiment of the optical system according to the disclosure for the surface of the immersion unit directed towards the sensor unit to be arranged fully at the detection surface of the sensor unit directed towards the immersion unit.

In one exemplary embodiment of the optical system according to the disclosure, provision is made in addition or as an alternative for the immersion unit to touch the second lens unit. In other words, the immersion unit is arranged directly at the second lens unit. In particular, provision is made for a surface of the immersion unit directed towards the second lens unit to touch a surface of the second lens unit directed towards the immersion unit. For example, provision is made for the immersion unit to touch the second lens unit in parts. In other words, provision is made in this exemplary embodiment of the optical system according to the disclosure for only a first part of the surface of the immersion unit directed towards the second lens unit to be directly arranged at the surface of the second lens unit directed towards the immersion unit. A second part of the surface of the immersion unit directed towards the second lens unit is not directly arranged at the surface of the second lens unit directed towards the immersion unit. The second part of the surface of the immersion unit directed towards the second lens unit is therefore arranged at a distance from the second lens unit. As an alternative thereto, provision is made for the immersion unit to touch the second lens unit in full. In other words, provision is made in this exemplary embodiment of the optical system according to the disclosure for the surface of the immersion unit directed towards the second lens unit to be arranged fully at the surface of the second lens unit directed towards the immersion unit.

In yet another exemplary embodiment of the optical system according to the disclosure, provision is made in addition or as an alternative for the immersion unit and the sensor unit to be arranged at a distance from one another. In particular, provision is made for the immersion unit to be at a distance from the sensor unit, which distance is hereinafter referred to as the immersion unit distance. For example, the immersion unit distance is the length of a straight path between a first point on a surface of the immersion unit directed towards the sensor unit and a second point on a surface of the sensor unit directed towards the immersion unit. In particular, the immersion unit distance is the shortest length of all possible straight paths between any first point on a surface of the immersion unit directed towards the sensor unit and any second point on a surface of the sensor unit directed towards the immersion unit. In the exemplary embodiment of the optical system according to the disclosure, provision is made for the following to apply to the immersion unit distance:

$$0 < IA \leq {λ}_{I}$$

where IA is the immersion unit distance and λ_{I} is a wavelength of the light incident into the optical system. The disclosure is not restricted to the aforementioned range of the immersion unit distance. Rather, any range of the immersion unit distance suitable for the disclosure can be used.

The exemplary embodiment of the optical system according to the disclosure which provides the immersion unit distance between the immersion unit and the sensor unit is particularly advantageous if the immersion unit and the sensor unit cannot be arranged directly next to one another. On account of the immersion unit distance, it is possible that the light incident into the optical system according to the disclosure reaches the sensor unit due to what is known as frustrated total internal reflection (FTIR) and can thus be detected by the sensor unit.

In one exemplary embodiment of the optical system according to the disclosure, provision is made in addition or as an alternative for at least one absorption unit to be arranged between the immersion unit and the sensor unit. Accordingly, this exemplary embodiment of the optical system according to the disclosure is provided, for example, when the immersion unit and the sensor unit are arranged at a distance from one another. In particular, provision is made for the absorption unit to be configured in such a way that the light of a certain wavelength range entering the absorption unit from the immersion unit is absorbed in the absorption unit. In addition or as an alternative, provision is made for the absorption unit to be configured in such a way that the absorption unit emits light of a further specific wavelength range, for example infrared radiation.

As already mentioned above, a further exemplary embodiment of the optical system according to the disclosure in addition or as an alternative provides for the absorption unit and the sensor unit to be arranged at a distance from one another. In particular, provision is made for the absorption unit to be at a distance from the sensor unit, which distance is hereinafter referred to as the absorption unit distance. For example, the absorption unit distance is the length of a straight path between a first point on a surface of the absorption unit directed towards the sensor unit and a second point on a surface of the sensor unit directed towards the absorption unit. In particular, the absorption unit distance is the shortest length of all possible straight paths between any first point on a surface of the absorption unit directed towards the sensor unit and any second point on a surface of the sensor unit directed towards the absorption unit. The aforementioned surface of the sensor unit is, for example, the detection surface of the sensor unit. In the exemplary embodiment of the optical system according to the disclosure, provision is made for the following to apply to the absorption unit distance:

$$0 < AA \leq {λ}_{A} ,$$

where AA is the absorption unit distance and λ_{A} is a wavelength of the light incident into the optical system. The disclosure is not restricted to the aforementioned range of the absorption unit distance. Rather, any range of the absorption unit distance suitable for the disclosure can be used.

It should be noted that the aforementioned wavelength λ_{I} of the light incident into the optical system according to the disclosure and the aforementioned wavelength λ_{A} of the light incident into the optical system according to the disclosure may be identical.

In yet another exemplary embodiment of the optical system according to the disclosure, it is in addition or as an alternative provided that the immersion unit has at least one of the following features: (i) at least one first immersion device in solid form, and (ii) at least one second immersion device in liquid form. The first immersion device in solid form includes, for example, silicon, germanium, zinc sulfide, chalcogenides, arsenide selenide (AsSe) and/or germanium arsenide selenide (GeAsSe). For example, the immersion unit is fully formed as first immersion device. In other words, the immersion unit is provided completely in solid form. The second immersion device in liquid form includes, for example, water, an oil and/or glycerol. For example, the immersion unit is fully formed as second immersion device. In other words, the immersion unit is provided completely in liquid form.

In one exemplary embodiment of the optical system according to the disclosure, provision is made in addition or as an alternative for the immersion unit to include at least one optical unit. The optical unit has at least one of the following features: (i) the optical unit is plane-parallel; (ii) a refractive index of the optical unit is larger than a refractive index of a medium adjacent to the immersion unit at the object side; (iii) the optical unit is configured to filter light; (iv) the optical unit is configured to filter infrared light. Explicit reference is made to the fact that the disclosure is not restricted to the aforementioned exemplary embodiments of the optical unit. Rather, any optical unit suitable for the disclosure can be used as optical unit. For example, the optical unit may be curved and/or formed as a microlens.

The disclosure also relates to a camera for imaging an object including an optical system having at least one of the features specified further above or specified below or a combination of at least two of the features specified further above or specified below. By way of example, this camera is configured as a thermal imaging camera and/or is arranged at a portable telephone, at a portable computer, at a vehicle, in a flying object (for example a drone or a satellite), at a manned aircraft or at an unmanned aircraft. In particular, provision is made for light from one of the following wavelength ranges to be captured using the camera according to the disclosure: the near-infrared range (0.7 μm to 3 μm), the mid-infrared range (3 μm to 50 μm) and the far-infrared range (50 μm to 1000 μm).

The disclosure further relates to a further optical system according to the disclosure, which is explained below. The further optical system according to the disclosure is provided for a camera for imaging an object. For example, the further optical system according to the disclosure and/or the camera at which the further optical system according to the disclosure is arranged is/are arranged at a portable telephone, at a portable computer, at a vehicle, in a flying object (for example a drone or a satellite), at a manned aircraft or at an unmanned aircraft. Explicit reference is made to the fact that the further optical system according to the disclosure is not restricted to the aforementioned embodiments. Rather, the further optical system according to the disclosure may be arranged at any optical device for which the further optical system according to the disclosure is suitable. By way of example, the further optical system according to the disclosure may be arranged in a pair of field glasses, in a refractor, in a telescope, in a spotting scope, or in a light microscope.

The further optical system according to the disclosure has at least one sensor unit. For example, the sensor unit is configured as a cooled sensor, as an uncooled sensor, as a CCD sensor, as a CMOS sensor, as an InGaAs sensor, as an InSb sensor, as an MCT sensor, as a QWIP sensor and/or as a microbolometer. The disclosure is not restricted to the aforementioned exemplary embodiments of the sensor unit. Rather, any sensor unit suitable for the disclosure can be used as sensor unit. The sensor unit can also be referred to as an electronic sensor unit. For example, the sensor unit has a plurality of pixels. Each pixel of the plurality of pixels is used to detect light incident on the pixel. Basically, a detection unit is arranged at each pixel. The detection unit detects light incident on the pixel and generates a detection signal depending on the incident light, said detection signal being passed to a processor unit, for example. The processor unit evaluates the detection signals passed to it and displays the evaluation, for example in the form of an image on a display unit. In addition or as an alternative thereto, provision is made for the detection signal and/or the image to be stored in a storage unit. In turn, in addition or as an alternative thereto, provision is made for the detection signal and/or the image to be forwarded to another unit, for example to another computer system.

In addition, the further optical system according to the disclosure includes at least one lens unit. For example, the lens unit is provided with a single lens. Further exemplary embodiments of the further optical system according to the disclosure make provision for the lens unit to include several lenses and/or several optical elements (for example in the form of a prism or a mirror). In a further exemplary embodiment of the further optical system according to the disclosure, the lens unit is formed as a lens group including several lenses and/or several optical elements. As an alternative, in yet another exemplary embodiment of the further optical system according to the disclosure, provision is made for the further optical system according to the disclosure to include at least one first lens group and at least one second lens group, each of the lens groups having several lenses and/or several optical elements.

The further optical system according to the disclosure is provided with at least one immersion unit, which has a refractive index n larger than 1. For example, the following applies to the refractive index n. 1<n≤6 or 1<n≤4. The immersion unit is arranged between the lens unit and the sensor unit. Further, the immersion unit is arranged both at the lens unit and at the sensor unit. In contrast to the prior art, the immersion unit is not arranged at the object, but at the sensor unit on which the object is imaged with the lens unit. By way of example, the immersion unit is in the form of a lens device. In particular, provision is made for the lens device to have a first side and a second side. The first side of the lens device is directed towards the lens unit and is curved, for example. The second side of the lens device is directed towards the sensor unit and is planar, for example. In a further exemplary embodiment of the further optical system according to the disclosure, provision is made in addition or as an alternative for the lens device to be provided with a single lens. Further exemplary embodiments of the further optical system according to the disclosure make provision for the lens device to include several lenses and/or several optical elements (for example in the form of a prism or a mirror). In a further exemplary embodiment of the further optical system according to the disclosure, the lens device is formed as a lens group including several lenses and/or several optical elements.

The further optical system according to the disclosure ensures that a larger numerical aperture NA of the optical system according to the disclosure can be achieved due to the arrangement of the immersion unit at the sensor unit. A larger numerical aperture NA of the further optical system according to the disclosure in contrast to the prior art leads to a smaller F-number of the further optical system according to the disclosure in comparison with the prior art. It is therefore possible to achieve a smaller resolution limit compared to the prior art (see equation [3]). Due to the larger numerical aperture of the further optical system according to the disclosure in comparison with the prior art, a higher resolution of the further optical system according to the disclosure in comparison with the prior art can also be achieved (see equation [5]).

In one exemplary embodiment of the further optical system according to the disclosure, provision is in addition or as an alternative made for the further optical system according to the disclosure to have alight incidence direction. The light incidence direction is the direction in which light, when viewed from the object, enters the further optical system according to the disclosure and in which the light passes through the further optical system according to the disclosure until it is detected by the sensor unit. When viewed from the object in the light incidence direction, first the lens unit, then the immersion unit and then the sensor unit are arranged along an optical axis of the further optical system according to the disclosure.

In a further exemplary embodiment of the further optical system according to the disclosure, provision is made in addition or as an alternative for the immersion unit to touch the sensor unit. In other words, the immersion unit is arranged directly at the sensor unit. In particular, provision is made for a surface of the immersion unit directed towards the sensor unit to touch a detection surface of the sensor unit directed towards the immersion unit. For example, provision is made for the immersion unit to touch the sensor unit in parts. In other words, provision is made in this exemplary embodiment of the further optical system according to the disclosure for only a first part of the surface of the immersion unit directed towards the sensor unit to be directly arranged at the detection surface of the sensor unit directed towards the immersion unit. A second part of the surface of the immersion unit directed towards the sensor unit is not directly arranged at the detection surface of the sensor unit directed towards the immersion unit. The second part of the surface of the immersion unit directed towards the sensor unit is therefore arranged at a distance from the sensor unit. As an alternative thereto, provision is made for the immersion unit to touch the sensor unit in full. In other words, provision is made in this exemplary embodiment of the further optical system according to the disclosure for the surface of the immersion unit directed towards the sensor unit to be arranged fully at the detection surface of the sensor unit directed towards the immersion unit.

In yet another exemplary embodiment of the further optical system according to the disclosure, provision is made in addition or as an alternative for the immersion unit to touch the lens unit. In other words, the immersion unit is arranged directly at the lens unit. In particular, provision is made for a surface of the immersion unit directed towards the lens unit to touch a surface of the lens unit directed towards the immersion unit. For example, provision is made for the immersion unit to touch the lens unit in parts. In other words, provision is made in this exemplary embodiment of the further optical system according to the disclosure for only a first part of the surface of the immersion unit directed towards the lens unit to be directly arranged at the surface of the lens unit directed towards the immersion unit. A second part of the surface of the immersion unit directed towards the lens unit is not directly arranged at the surface of the lens unit directed towards the immersion unit. The second part of the surface of the immersion unit directed towards the lens unit is therefore arranged at a distance from the lens unit. As an alternative thereto, provision is made for the immersion unit to touch the lens unit in full. In other words, provision is made in this exemplary embodiment of the further optical system according to the disclosure for the surface of the immersion unit directed towards the lens unit to be arranged fully at the surface of the lens unit directed towards the immersion unit.

In yet another exemplary embodiment of the further optical system according to the disclosure, provision is made in addition or as an alternative for the immersion unit and the sensor unit to be arranged at a distance from one another. In particular, provision is made for the immersion unit to be at a distance from the sensor unit, which distance is hereinafter referred to as the immersion unit distance. For example, the immersion unit distance is the length of a straight line between a first point on a surface of the immersion unit directed towards the sensor unit and a second point on a surface of the sensor unit directed towards the immersion unit. In particular, the immersion unit distance is the shortest length of all possible straight lines between any first point on a surface of the immersion unit directed towards the sensor unit and any second point on a surface of the sensor unit directed towards the immersion unit. In the exemplary embodiment of the further optical system according to the disclosure, provision is made for the following to apply to the immersion unit distance:

$$0 < IA \leq 4 \cdot {λ}_{I} ,$$

where IA is the immersion unit distance and λ_{I} is a wavelength of the light incident into the optical system. The disclosure is not restricted to the aforementioned range of the immersion unit distance. Rather, any range of the immersion unit distance suitable for the disclosure can be used.

The exemplary embodiment of the further optical system according to the disclosure which provides the immersion unit distance between the immersion unit and the sensor unit is particularly advantageous if the immersion unit and the sensor unit cannot be arranged directly next to one another. On account of the immersion unit distance, it is possible that the light incident into the further optical system according to the disclosure reaches the sensor unit due to what is known as FTIR and can thus be detected by the sensor unit.

In one exemplary embodiment of the further optical system according to the disclosure, provision is made in addition or as an alternative for at least one absorption unit to be arranged between the immersion unit and the sensor unit. Accordingly, this exemplary embodiment of the further optical system according to the disclosure is provided, for example, when the immersion unit and the sensor unit are arranged at a distance from one another. In particular, provision is made for the absorption unit to be configured in such a way that the light of a certain wavelength range entering the absorption unit from the immersion unit is absorbed in the absorption unit. In addition or as an alternative, provision is made for the absorption unit to be configured in such a way that the absorption unit emits light of a further specific wavelength range, for example infrared radiation.

As already mentioned above, a further exemplary embodiment of the further optical system according to the disclosure in addition or as an alternative provides for the absorption unit and the sensor unit to be arranged at a distance from one another. In particular, provision is made for the absorption unit to be at a distance from the sensor unit, which distance is hereinafter referred to as the absorption unit distance. For example, the absorption unit distance is the length of a straight line between a first point on a surface of the absorption unit directed towards the sensor unit and a second point on a surface of the sensor unit directed towards the absorption unit. In particular, the absorption unit distance is the shortest length of all possible straight lines between any first point on a surface of the absorption unit directed towards the sensor unit and any second point on a surface of the sensor unit directed towards the absorption unit. The aforementioned surface of the sensor unit is, for example, the detection surface of the sensor unit. In the exemplary embodiment of the further optical system according to the disclosure, provision is made for the following to apply to the absorption unit distance:

$$0 < AA \leq 4 \cdot {λ}_{A} ,$$

where AA is the absorption unit distance and λ_{A} is a wavelength of the light incident into the optical system. The disclosure is not restricted to the aforementioned range of the absorption unit distance. Rather, any range of the absorption unit distance suitable for the disclosure can be used.

It should be noted that the aforementioned wavelength λ_{I} of the light incident into the further optical system according to an aspect of the disclosure and the aforementioned wavelength λ_{A} of the light incident into the further optical system according to an aspect of the disclosure may be identical.

In yet another exemplary embodiment of the further optical system according to the disclosure, it is in addition or as an alternative provided that the immersion unit has at least one of the following features: (i) at least one first immersion device in solid form, and (ii) at least one second immersion device in liquid form. The first immersion device in solid form includes, for example, silicon, germanium, zinc sulfide, chalcogenides, AsSe and/or GeAsSe. For example, the immersion unit is fully formed as first immersion device. In other words, the immersion unit is provided completely in solid form. The second immersion device in liquid form includes, for example, water, an oil and/or glycerol. For example, the immersion unit is fully formed as second immersion device. In other words, the immersion unit is provided completely in liquid form.

The disclosure also relates to a further camera for imaging an object including a further optical system having at least one of the features specified further above or specified below or a combination of at least two of the features specified further above or specified below. By way of example, this camera is configured as a thermal imaging camera and/or is arranged at a portable telephone, at a portable computer, at a vehicle, in a flying object (for example a drone or a satellite), at a manned aircraft or at an unmanned aircraft. In particular, provision is made for light from one of the following wavelength ranges to be captured using the further camera according to the disclosure: the near-infrared range (0.7 μm to 3 μm), the mid-infrared range (3 μm to 50 μm) and the far-infrared range (50 μm to 1000 μm).

In the following, the properties of the further optical system according to the disclosure and the further optical camera according to the disclosure are summarized again.

### Property 1:

An optical system for a camera for imaging an object, including:
at least one sensor unit,
at least one lens unit for imaging the object to the sensor unit, and
at least one immersion unit having a refractive index larger than 1,
   wherein
the immersion unit is arranged between the lens unit and the sensor unit,
the immersion unit is arranged at the lens unit, and wherein
the immersion unit is arranged at the sensor unit.

### Property 2:

Optical system according to property 1, wherein:
the optical system has a light incidence direction, and
when viewed in the light incidence direction, first the lens unit, then the immersion unit and then the sensor unit are arranged along an optical axis of the optical system.

### Property 3:

Optical system according to property 1 or 2, wherein the immersion unit touches the sensor unit.

### Property 4:

Optical system according to one of the preceding properties, wherein the optical system has at least one of the following features:
(i) the immersion unit and the sensor unit are arranged at a distance from one another, and
(ii) the immersion unit is at an immersion unit distance from the sensor unit, wherein the following applies to the immersion unit distance:

$$0 < IA \leq 4 \cdot {λ}_{I} ,$$

where IA is the immersion unit distance and λ_{I} is a wavelength of the light incident into the optical system.

### Property 5:

Optical system according to one of the preceding properties, wherein at least one absorption unit is arranged between the immersion unit and the sensor unit.

### Property 6:

Optical system according to property 5, wherein the optical system has at least one of the following features:
(i) the absorption unit is configured to filter infrared light,
(ii) the absorption unit is configured to generate infrared light,
(iii) the absorption unit and the sensor unit are arranged at a distance from one another, and
(iv) the absorption unit is at an absorption unit distance from the sensor unit, wherein the following applies to the absorption unit distance:

$$0 < AA \leq 4 \cdot {λ}_{A} ,$$

where AA is the absorption unit distance and λ_{A} is a wavelength of the light incident into the optical system.

### Property 7:

Optical system according to one of the preceding properties, wherein the immersion unit has at least one of the following features:
(i) at least one first immersion device in solid form, and
(ii) at least one second immersion device in liquid form.

### Property 8:

Camera for imaging an object having an optical system according to one of the preceding properties.

### Property 9:

Camera according to property 8, wherein the camera is configured as a thermal imaging camera.

### BRIEF DESCRIPTION OF THE DRAWINGS

The disclosure will now be described with reference to the drawings wherein:

FIG. 1 shows a schematic representation of a camera having an optical system according to a first exemplary embodiment of the disclosure;

FIG. 2 shows a schematic representation of a camera having an optical system according to a second exemplary embodiment of the disclosure;

FIG. 3 shows a schematic representation of a camera having an optical system according to a third exemplary embodiment of the disclosure;

FIG. 4 shows a schematic representation of a camera having an optical system according to a fourth exemplary embodiment of the disclosure;

FIG. 5 shows a schematic representation of a camera having an optical system according to a fifth exemplary embodiment of the disclosure;

FIG. 6 shows a schematic representation of a camera having an optical system according to a sixth exemplary embodiment of the disclosure; and

FIG. 7 shows a schematic representation of a camera having an optical system according to a seventh exemplary embodiment of the disclosure.

### DESCRIPTION OF EXEMPLARY EMBODIMENTS

An optical system 100 according to the disclosure is now explained in more detail using the example of a camera 200. By way of example, the camera 200 is configured as a thermal imaging camera and/or is arranged at a portable telephone, at a portable computer, at a vehicle, in a flying object (for example a drone or a satellite), at a manned aircraft or at an unmanned aircraft. In particular, provision is made for light from one of the following wavelength ranges to be captured using the camera 200 according to the disclosure: the near-infrared range (0.7 μm to 3 μm), the mid-infrared range (3 μm to 50 μm) and the far-infrared range (50 μm to 1000 μm). Explicit reference is made to the fact that the optical system 100 is not restricted to the aforementioned exemplary embodiments. Rather, the optical system 100 may be arranged at any optical device for which the optical system 100 is suitable. By way of example, the optical system 100 may be arranged in a pair of field glasses, in a refractor, in a telescope, in a spotting scope, or in a light microscope.

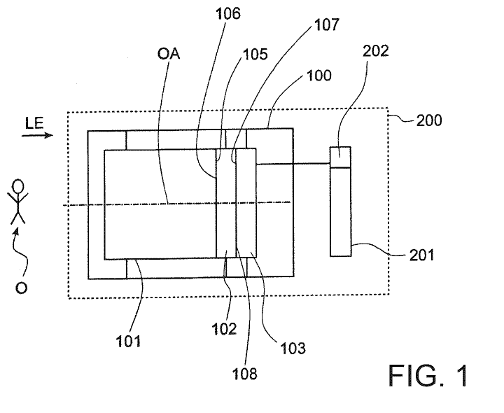

FIG. 1 shows a schematic representation of an exemplary embodiment of the camera 200 for imaging an object O. The camera 200 includes the optical system 100. In the exemplary embodiment illustrated in FIG. 1, the optical system 100 includes a lens unit 101, an immersion unit 102 and a sensor unit 103.

The lens unit 101 is configured to image the object O onto the sensor unit 103. By way of example, the lens unit 101 is in the form of a lens system. In one exemplary embodiment of the lens unit 101, the lens unit 101 is provided with a single lens. Further exemplary embodiments of the lens unit 101 make provision for the lens unit 101 to include several lenses and/or several optical elements (for example in the form of a prism or a mirror). In a further exemplary embodiment, the lens unit 101 is formed as a lens group including several lenses and/or several optical elements. As an alternative, in yet another exemplary embodiment, provision is made for the lens unit 101 to include at least one first lens group and at least one second lens group, each of the lens groups having several lenses and/or several optical elements.

The sensor unit 103 detects light rays which pass in the light incidence direction LE from the object O through the lens unit 101 and generates detection signals. The light incidence direction LE is the direction in which light, when from viewed from the object O, enters the optical system 100 and in which the light passes through the optical system 100 until it is detected by the sensor unit 103.

For example, the sensor unit 103 has a sensor surface with a plurality of pixels. Each pixel of the plurality of pixels is used to detect light incident on the pixel. Basically, a detection unit is arranged at each pixel. The detection unit detects light incident on the pixel and generates a detection signal depending on the incident light, said detection signal being passed to a processor unit 202 of the camera 200, for example. The processor unit 202 evaluates the detection signals passed to it and displays the evaluation, for example, in the form of an image on a display unit 201 of the camera 200. The display unit 201 is formed, for example, as a field emission screen, as a liquid crystal screen, as a thin film transistor screen, as a plasma screen, as a surface conduction electron emitter display (SED) or as a screen having organic light emitting diodes. The above enumeration is not exhaustive. Rather, any display unit suitable for the disclosure can be used as display unit 201. In addition or as an alternative thereto, provision is made for storing the detection signals and/or the image in a storage unit. In turn, in addition or as an alternative thereto, provision is made for the detection signals and/or the image to be forwarded to another unit, for example to another computer system.

For example, the sensor unit 103 is configured as a cooled sensor, as an uncooled sensor, as a CCD sensor, as a CMOS sensor, as an InGaAs sensor, as an InSb sensor, as an MCT sensor, as a QWIP sensor and/or as a microbolometer. The disclosure is not restricted to the aforementioned exemplary embodiments of the sensor unit 103. Rather, any sensor unit suitable for the disclosure can be used as sensor unit 103.

The immersion unit 102 has a refractive index n, to which the following applies: n>1. For example, the following applies to the refractive index n. 1<n≤6 or 1<n≤4. By way of example, the immersion unit 102 is in the form of a lens device. Reference is made to the explanations provided above in respect of the lens device, which also apply here. The immersion unit 102 is arranged between the lens unit 101 and the sensor unit 103. Further, the immersion unit 102 is arranged both at the lens unit 101, and also at the sensor unit 103. In contrast to the prior art, the immersion unit 102 is not arranged at the object O, but at the sensor unit 103 onto which the object O is imaged with the lens unit 101. In the exemplary embodiment illustrated in FIG. 1, when viewed from the object O in the light incidence direction LE, first the lens unit 101, then the immersion unit 102, and then the sensor unit 103 are arranged along an optical axis OA of the optical system 100. Further, in the exemplary embodiment of the optical system 100 illustrated in FIG. 1, a first surface 105 of the immersion unit 102 directed towards the lens unit 101 touches a first surface 106 of the lens unit 101 directed towards the immersion unit 102. A second surface 107 of the immersion unit 102 directed towards the sensor unit 103 touches a detection surface 108 of the sensor unit 103 directed towards the immersion unit 102. In other words, the first surface 105 of the immersion unit 102 directed towards the lens unit 101 is arranged directly at the first surface 106 of the lens unit 101 directed towards the immersion unit 102. The second surface 107 of the immersion unit 102 directed towards the sensor unit 103 is directly arranged at the detection surface 108 of the sensor unit 103 directed towards the immersion unit 102. The immersion unit 102 touches the lens unit 101 and the sensor unit 103 in full. In other words, provision is made in this exemplary embodiment of the optical system 100 for the first surface 105 of the immersion unit 102 directed towards the lens unit 101 to be arranged fully at the first surface 106 of the lens unit 101 directed towards the immersion unit 102. In addition or as an alternative, provision is made for the second surface 107 of the immersion unit 102 directed towards the sensor unit 103 to be arranged fully at the detection surface 108 of the sensor unit 103 directed towards the immersion unit 102.

In one exemplary embodiment of the optical system 100, provision is made for the first surface 105 of the immersion unit 102 directed towards the lens unit 101 to touch the first surface 106 of the lens unit 101 directed towards the immersion unit 102 in parts. In other words, provision is made in this exemplary embodiment of the optical system 100, for example, for only a first part of the first surface 105 of the immersion unit 102 directed towards the lens unit 101 to be directly arranged at the first surface 106 of the lens unit 101 directed towards the immersion unit 102. A second part of the first surface 105 of the immersion unit 102 directed towards the lens unit 101 is not directly arranged at the first surface 106 of the lens unit 101 directed towards the immersion unit 102. The second part of the first surface 105 of the immersion unit 102 directed towards the lens unit 101 is accordingly arranged at a distance from the first surface 106 of the lens unit 101 directed towards the immersion unit 102.

In a further exemplary embodiment of the optical system 100, provision is made for the second surface 107 of the immersion unit 102 directed towards the sensor unit 103 to touch the detection surface 108 of the sensor unit 103 directed towards the immersion unit 102 in parts. In other words, provision is made in this exemplary embodiment of the optical system 100, for example, for only a first part of the second surface 107 of the immersion unit 102 directed towards the sensor unit 103 to be directly arranged at the detection surface 108 of the sensor unit 103 directed towards the immersion unit 102. A second part of the second surface 107 of the immersion unit 102 directed towards the sensor unit 103 is not directly arranged at the detection surface 108 of the sensor unit 103 directed towards the immersion unit 102. The second part of the second surface 107 of the immersion unit 102 directed towards the sensor unit 103 is arranged at a distance from the detection surface 108 of the sensor unit 103 directed towards the immersion unit 102.

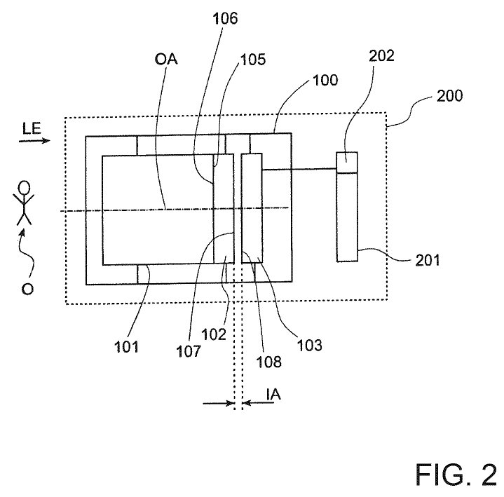

FIG. 2 shows a schematic representation of a further exemplary embodiment of the camera 200 for imaging an object O. The exemplary embodiment of FIG. 2 is based on the exemplary embodiment of FIG. 1. Therefore, reference is made to the comments above, which also apply here. Identical components are provided with identical reference signs. In contrast to the exemplary embodiment of FIG. 1, in the exemplary embodiment of FIG. 2 provision is made for the immersion unit 102 and the sensor unit 103 to be arranged at a distance from one another. In other words, the second surface 107 of the immersion unit 102 directed towards the sensor unit 103 is arranged at a distance from the detection surface 108 of the sensor unit 103 directed towards the immersion unit 102. The immersion unit 102 is at a distance from the sensor unit 103, which distance is referred to as the immersion unit distance IA. For example, the immersion unit distance IA is the length of a straight line between a first point on the second surface 107 of the immersion unit 102 directed towards the sensor unit 103 and a second point on a detection surface 108 of the sensor unit 103 directed towards the immersion unit 102. In the exemplary embodiment of the optical system 100 illustrated in FIG. 2, provision is made for the following to apply to the immersion unit distance IA:

$$0 < IA \leq 4 \cdot {λ}_{I} ,$$

where IA is the immersion unit distance and λ_{I} is a wavelength of the light incident into the optical system 100. The disclosure is not restricted to the aforementioned range of the immersion unit distance IA. Rather, any range of the immersion unit distance IA suitable for the disclosure can be used. The exemplary embodiment of the optical system 100 illustrated in FIG. 2 is particularly advantageous if the immersion unit 102 and the sensor unit 103 cannot be arranged directly next to one another. On account of the immersion unit distance IA, it is possible that the light incident into the optical system 100 reaches the sensor unit 103 due to what is known as FTIR and can thus be detected by the sensor unit 103.

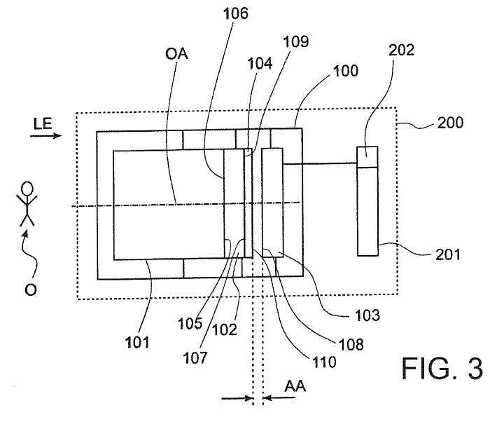

FIG. 3 shows a schematic representation of a further exemplary embodiment of the camera 200 for imaging an object O. The exemplary embodiment of FIG. 3 is based on the exemplary embodiment of FIG. 1. Therefore, reference is made to the comments above, which also apply here. Identical components are provided with identical reference signs. In contrast to the exemplary embodiment of FIG. 1, in the exemplary embodiment of FIG. 3, provision is made for at least one absorption unit 104 to be arranged between the immersion unit 102 and the sensor unit 103. In the exemplary embodiment illustrated in FIG. 3, when viewed from the object O in the light incidence direction LE, first the lens unit 101, then the immersion unit 102, then the absorption unit 104, and then the sensor unit 103 are arranged along an optical axis OA of the optical system 100.

Further, in the exemplary embodiment of the optical system 100 illustrated in FIG. 3, a first surface 109 of the absorption unit 104 directed towards the immersion unit 102 touches the second surface 107 of the immersion unit 102 directed towards the absorption unit 104. In other words, the first surface 109 of the absorption unit 104 directed towards the immersion unit 102 is arranged directly at the second surface 107 of the immersion unit 102 directed towards the absorption unit 104. The absorption unit 104 touches the immersion unit 102 in full. In other words, provision is made in this exemplary embodiment of the optical system 100 for the first surface 109 of the absorption unit 104 directed towards the immersion unit 102 to be arranged fully at the second surface 107 of the immersion unit 102 directed towards the absorption unit 104.

In one exemplary embodiment of the optical system 100, provision is made for the first surface 109 of the absorption unit 104 directed towards the immersion unit 102 to touch the second surface 107 of the immersion unit 102 directed towards the absorption unit 104 in parts. In other words, provision is made in this exemplary embodiment of the optical system 100, for example, for only a first part of the first surface 109 of the absorption unit 104 directed towards the immersion unit 102 to be directly arranged at the second surface 107 of the immersion unit 102 directed towards the absorption unit 104. A second part of the first surface 109 of the absorption unit 104 directed towards the immersion unit 102 is not directly arranged at the second surface 107 of the immersion unit 102 directed towards the absorption unit 104. The second part of the first surface 109 of the absorption unit 104 directed towards the immersion unit 102 is accordingly arranged at a distance from the second surface 107 of the immersion unit 102 directed towards the absorption unit 104.

In the exemplary embodiment of FIG. 3, provision is made for the absorption unit 104 and the sensor unit 103 to be arranged at a distance from one another. In other words, the second surface 110 of the absorption unit 104 directed towards the sensor unit 103 is arranged at a distance from the detection surface 108 of the sensor unit 103 directed towards the absorption unit 104. The absorption unit 104 is at a distance from the sensor unit 103, which distance is referred to in the following as the absorption unit distance AA. For example, the absorption unit distance AA is the length of a straight line between a first point on the second surface 110 of the absorption unit 104 directed towards the sensor unit 103 and a second point on a detection surface 108 of the sensor unit 103 directed towards the absorption unit 104. In the exemplary embodiment of the optical system 100 illustrated in FIG. 3, provision is made for the following to apply to the absorption unit distance AA:

$$0 < AA \leq 4 \cdot {λ}_{A} ,$$

where AA is the absorption unit distance and λ_{A} is a wavelength of the light incident into the optical system 100. The disclosure is not restricted to the aforementioned range of the absorption unit distance AA. Rather, any range of the absorption unit distance AA suitable for the disclosure can be used. It should be noted that the aforementioned wavelength λ_{I} of the light incident into the optical system 100 and the aforementioned wavelength λ_{A} of the light incident into the optical system 100 may be identical.

The absorption unit 104 is configured in such a way that the light of a certain wavelength range entering the absorption unit 104 from the immersion unit 102 is absorbed in the absorption unit 104. In addition or as an alternative thereto, provision is made for the absorption unit 104 to be configured in such a way that the absorption unit 104 emits light of a further specific wavelength range, for example infrared radiation.

The optical system 100 and the camera 200 ensure that, in contrast to the prior art, a larger numerical aperture NA of the optical system 100 can be achieved due to the immersion unit 102. A larger numerical aperture NA of the optical system 100 in contrast to the prior art leads to a smaller F-number of the optical system 100 in comparison with the prior art. It is therefore possible to achieve a smaller resolution limit compared to the prior art (see equation [3]). Due to the larger numerical aperture NA of the optical system 100 in comparison with the prior art, a higher resolution of the optical system 100 in comparison with the prior art can accordingly also be achieved (see equation [5]).

In one exemplary embodiment of the optical system 100, the immersion unit 102 has at least one of the following features: (i) at least one first immersion device in solid form, and (ii) at least one second immersion device in liquid form. The first immersion device in solid form includes, for example, silicon, germanium, zinc sulfide, chalcogenides, AsSe and/or GeAsSe. For example, the immersion unit 102 is fully formed as first immersion device. In other words, the immersion unit 102 is provided completely in solid form. The second immersion device in liquid form includes, for example, water, an oil and/or glycerol. For example, the immersion unit 102 is fully formed as second immersion device. In other words, the immersion unit 102 is provided completely in liquid form.

As already mentioned above, the numerical aperture NA corresponds to the variable

$$n \cdot sin θ$$

where n is the refractive index at a plane of the image of the object O generated by the optical system 100, wherein the plane is the detection surface of the sensor unit 103 of the optical system 100, and θ is half the angle of incidence of marginal rays of the light beam incident on the sensor unit 103.

At a typical half the angle of incidence of 30° and assuming that the immersion unit 102 has a first immersion device in solid form, namely in the form of germanium with a refractive index of n=4, a numerical aperture of NA=2 results. Considerations have shown that, with such a numerical aperture NA, the resolution of a sensor unit 103 with 640×480 pixels can be increased in such a way that it corresponds to a resolution of a sensor unit with 1920×1080 pixels, wherein the detection surface of the sensor unit 103 on which the pixels are arranged is approximately the same size as the detection surface of a commercially available sensor unit with 1920×1080 pixels. Further, considerations have shown that, with such a numerical aperture NA, the resolution of a sensor unit 103 with 1280×1024 pixels can be increased in such a way that it corresponds to a resolution of a sensor unit with 3840×2160 pixels, wherein the detection surface of the sensor unit 103 on which the pixels are arranged is smaller than a commercially available sensor unit with 3840×2160 pixels.

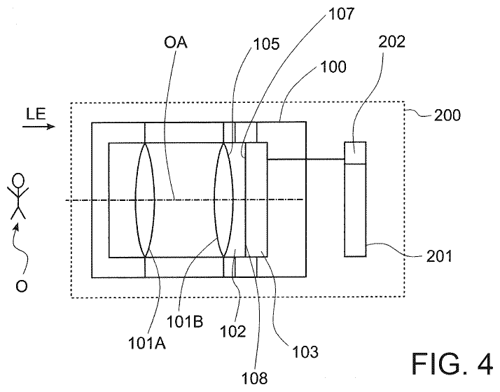

FIG. 4 shows a schematic representation of a further exemplary embodiment of the camera 200 for imaging an object O. The embodiment of FIG. 4 is based on the exemplary embodiment of FIG. 1. Therefore, reference is made to the comments above, which also apply here. Identical components are provided with identical reference signs. The differences between the exemplary embodiment of FIG. 4 and the exemplary embodiment of FIG. 1 are discussed below.

In contrast with the exemplary embodiment of FIG. 1, the exemplary embodiment of FIG. 4 provides for the optical system 100 to include a first lens unit 101A and a second lens unit 101n.

The first lens unit 101A is formed together with the second lens unit 101B and the immersion unit 102 for imaging the object O onto the sensor unit 103. In one exemplary embodiment of the first lens unit 101A, the first lens unit 101A is provided with a single lens. Further exemplary embodiments of the first lens unit 101A make provision for the first lens unit 101A to include several lenses and/or several optical elements (for example in the form of a prism or a mirror). In a further exemplary embodiment, the first lens unit 101A is formed as a lens group including several lenses and/or several optical elements. As an alternative, in yet another exemplary embodiment, provision is made for the first lens unit 101A to include at least one first lens group and at least one second lens group, each of the lens groups having several lenses and/or several optical elements.

In one exemplary embodiment of the second lens unit 101B, the second lens unit 101B is provided with a single lens. Further exemplary embodiments of the second lens unit 101B make provision for the second lens unit 101B to include several lenses and/or several optical elements (for example in the form of a prism or a mirror). In a further exemplary embodiment, the second lens unit 101B is formed as a lens group including several lenses and/or several optical elements. As an alternative, in yet another exemplary embodiment, provision is made for the second lens unit 101B to include at least one first lens group and at least one second lens group, each of the lens groups having several lenses and/or several optical elements.

When viewed in the light incidence direction LE, first the first lens unit 101A, then the second lens unit 101B, then the immersion unit 102 and then the sensor unit 103 are arranged along the optical axis OA. Further, the second lens unit 101B and the immersion unit 102 together have positive refractive power. In this respect, the second lens unit 101B and the immersion unit 102 behave like a converging lens.

The immersion unit 102 has, for example, a refractive index (that is to say a refractive number) n larger than 1. In particular, the following applies to the refractive index n: 1<n≤6 or 1<n≤4. For example, the refractive index of the immersion unit 102 is larger than a refractive index of a medium adjacent to the immersion unit 102 at the object side. For example, the medium is air or the second lens unit 101B. In a further exemplary embodiment, the refractive index of the immersion unit 102 is very similar to or identical to the refractive index of a medium adjacent to the immersion unit 102 at the object side. For example, the refractive index of the immersion unit 102 and the refractive index of the medium adjacent to the immersion unit 102 at the object side differ by +0.01 or +0.02.

The immersion unit 102 is arranged between the second lens unit 101B and the sensor unit 103. Further, the immersion unit 102 is arranged both at the second lens unit 101B and at the sensor unit 103. In contrast to the prior art, the immersion unit 102 is not arranged at the object O, but at the sensor unit 103 onto which the object O is imaged with the first lens unit 101A and the second lens unit 101B. In the exemplary embodiment of the optical system 100 illustrated in FIG. 4, a first surface 105 of the immersion unit 102 directed towards the second lens unit 101B can touch a first surface of the second lens unit 101B directed towards the immersion unit 102. As an alternative thereto, the first surface 105 of the immersion unit 102 directed towards the second lens unit 101B can be arranged at a distance from the first surface of the second lens unit 101B directed towards the immersion unit 102. A second surface 107 of the immersion unit 102 directed towards the sensor unit 103 touches a detection surface 108 of the sensor unit 103 directed towards the immersion unit 102. In other words, the second surface 107 of the immersion unit 102 directed towards the sensor unit 103 can be arranged directly at the detection surface 108 of the sensor unit 103 directed towards the immersion unit 102. The immersion unit 102 can touch the second lens unit 101B and the sensor unit 103 in full. In other words, provision is made in this exemplary embodiment of the optical system 100 for the first surface 105 of the immersion unit 102 directed towards the second lens unit 101B to be arranged fully at the first surface of the second lens unit 101B directed towards the immersion unit 102. In addition or as an alternative, provision is made for the second surface 107 of the immersion unit 102 directed towards the sensor unit 103 to be arranged fully at the detection surface 108 of the sensor unit 103 directed towards the immersion unit 102.

In one exemplary embodiment of the optical system 100 according to FIG. 4, provision is made for the first surface 105 of the immersion unit 102 directed towards the second lens unit 101B to touch the first surface of the second lens unit 101B directed towards the immersion unit 102 in parts. In other words, provision is made in this exemplary embodiment of the optical system 100 according to FIG. 4, for example, for only a first part of the first surface 105 of the immersion unit 102 directed towards the second lens unit 101B to be directly arranged at the first surface of the second lens unit 101B directed towards the immersion unit 102. A second part of the first surface 105 of the immersion unit 102 directed towards the second lens unit 101B is not directly arranged at the first surface of the second the lens unit 101B directed towards the immersion unit 102. The second part of the first surface 105 of the immersion unit 102 directed towards the second lens unit 101B is accordingly arranged at a distance from the first surface of the second lens unit 101B directed towards the immersion unit 102.

In a further exemplary embodiment of the optical system 100 according to FIG. 4, provision is made for the second surface 107 of the immersion unit 102 directed towards the sensor unit 103 to touch the detection surface 108 of the sensor unit 103 directed towards the immersion unit 102 in parts. In other words, provision is made in this exemplary embodiment of the optical system 100 according to FIG. 4, for example, for only a first part of the second surface 107 of the immersion unit 102 directed towards the sensor unit 103 to be directly arranged at the detection surface 108 of the sensor unit 103 directed towards the immersion unit 102. A second part of the second surface 107 of the immersion unit 102 directed towards the sensor unit 103 is not directly arranged at the detection surface 108 of the sensor unit 103 directed towards the immersion unit 102. The second part of the second surface 107 of the immersion unit 102 directed towards the sensor unit 103 is arranged at a distance from the detection surface 108 of the sensor unit 103 directed towards the immersion unit 102.

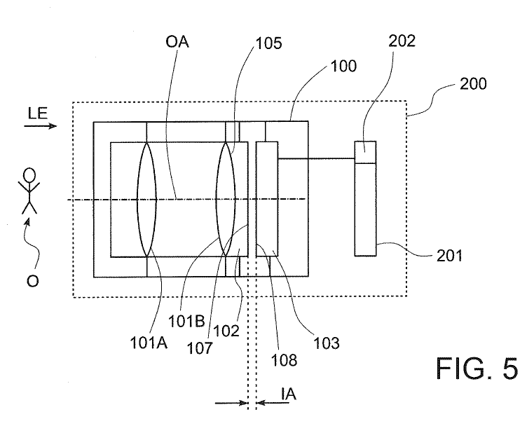

FIG. 5 shows a schematic representation of a further exemplary embodiment of the camera 200 for imaging an object O. The exemplary embodiment of FIG. 5 is based on the exemplary embodiment of FIG. 4. Therefore, reference is made to the comments above, which also apply here. Identical components are provided with identical reference signs. In contrast to the exemplary embodiment of FIG. 4, in the exemplary embodiment of FIG. 5 provision is made for the immersion unit 102 and the sensor unit 103 to be arranged at a distance from one another. In other words, the second surface 107 of the immersion unit 102 directed towards the sensor unit 103 is arranged at a distance from the detection surface 108 of the sensor unit 103 directed towards the immersion unit 102. The immersion unit 102 is at a distance from the sensor unit 103, which distance is referred to as the immersion unit distance IA. For example, the immersion unit distance IA is the length of a straight path between a first point on the second surface 107 of the immersion unit 102 directed towards the sensor unit 103 and a second point on a detection surface 108 of the sensor unit 103 directed towards the immersion unit 102. In the exemplary embodiment of the optical system 100 illustrated in FIG. 5, provision is made for the following to apply to the immersion unit distance IA:

$$0 < IA \leq {λ}_{I} ,$$

where IA is the immersion unit distance and λ_{I} is a wavelength of the light incident into the optical system 100. The disclosure is not restricted to the aforementioned range of the immersion unit distance IA. Rather, any range of the immersion unit distance IA suitable for the disclosure can be used. The exemplary embodiment of the optical system 100 illustrated in FIG. 5 is particularly advantageous if the immersion unit 102 and the sensor unit 103 cannot be arranged directly next to one another. On account of the immersion unit distance IA, it is possible that the light incident into the optical system 100 reaches the sensor unit 103 due to what is known as FTIR and can thus be detected by the sensor unit 103.

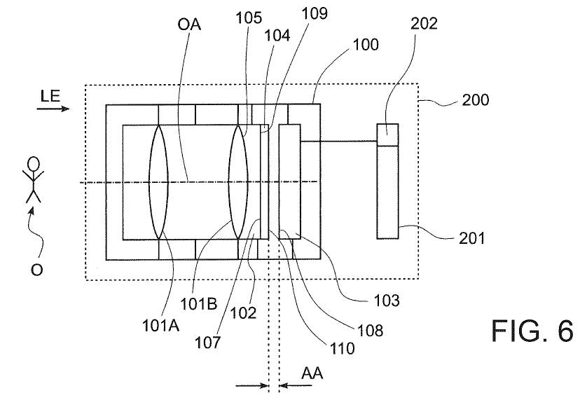

FIG. 6 shows a schematic representation of a further exemplary embodiment of the camera 200 for imaging an object O. The exemplary embodiment of FIG. 6 is based on the exemplary embodiment of FIG. 4. Therefore, reference is made to the comments above, which also apply here. Identical components are provided with identical reference signs. In contrast to the exemplary embodiment of FIG. 4, in the exemplary embodiment of FIG. 6, provision is made for at least one absorption unit 104 to be arranged between the immersion unit 102 and the sensor unit 103. In the exemplary embodiment illustrated in FIG. 6, when viewed from the object O in the light incidence direction LE, first the first lens unit 101A, then the second lens unit 101B, then the immersion unit 102, then the absorption unit 104, and then the sensor unit 103 are arranged along an optical axis OA of the optical system 100.

Further, in the exemplary embodiment of the optical system 100 illustrated in FIG. 6, a first surface 109 of the absorption unit 104 directed towards the immersion unit 102 touches the second surface 107 of the immersion unit 102 directed towards the absorption unit 104. In other words, the first surface 109 of the absorption unit 104 directed towards the immersion unit 102 is arranged directly at the second surface 107 of the immersion unit 102 directed towards the absorption unit 104. The absorption unit 104 touches the immersion unit 102 in full. In other words, provision is made in this exemplary embodiment of the optical system 100 for the first surface 109 of the absorption unit 104 directed towards the immersion unit 102 to be arranged fully at the second surface 107 of the immersion unit 102 directed towards the absorption unit 104.

In one exemplary embodiment of the optical system 100 according to FIG. 6, provision is made for the first surface 109 of the absorption unit 104 directed towards the immersion unit 102 to touch the second surface 107 of the immersion unit 102 directed towards the absorption unit 104 in parts. In other words, provision is made in this exemplary embodiment of the optical system 100 according to FIG. 6, for example, for only a first part of the first surface 109 of the absorption unit 104 directed towards the immersion unit 102 to be directly arranged at the second surface 107 of the immersion unit 102 directed towards the absorption unit 104. A second part of the first surface 109 of the absorption unit 104 directed towards the immersion unit 102 is not directly arranged at the second surface 107 of the immersion unit 102 directed towards the absorption unit 104. The second part of the first surface 109 of the absorption unit 104 directed towards the immersion unit 102 is accordingly arranged at a distance from the second surface 107 of the immersion unit 102 directed towards the absorption unit 104.

In the exemplary embodiment of FIG. 6, provision is made for the absorption unit 104 and the sensor unit 103 to be arranged at a distance from one another. In other words, the second surface 110 of the absorption unit 104 directed towards the sensor unit 103 is arranged at a distance from the detection surface 108 of the sensor unit 103 directed towards the absorption unit 104. The absorption unit 104 is at a distance from the sensor unit 103, which distance is referred to in the following as the absorption unit distance AA. For example, the absorption unit distance AA is the length of a straight path between a first point on the second surface 110 of the absorption unit 104 directed towards the sensor unit 103 and a second point on a detection surface 108 of the sensor unit 103 directed towards the absorption unit 104. In the exemplary embodiment of the optical system 100 illustrated in FIG. 6, provision is made for the following to apply to the absorption unit distance AA:

$$0 < AA \leq {λ}_{A} ,$$

where AA is the absorption unit distance and λ_{A} is a wavelength of the light incident into the optical system 100. The disclosure is not restricted to the aforementioned range of the absorption unit distance AA. Rather, any range of the absorption unit distance AA suitable for the disclosure can be used. It should be noted that the aforementioned wavelength λ_{I} of the light incident into the further optical system 100 and the aforementioned wavelength λ_{A} of the light incident into the optical system 100 may be identical.

The absorption unit 104 is configured in such a way that the light of a certain wavelength range entering the absorption unit 104 from the immersion unit 102 is absorbed in the absorption unit 104. In addition or as an alternative thereto, provision is made for the absorption unit 104 to be configured in such a way that the absorption unit 104 emits light of a further specific wavelength range, for example infrared radiation.

In one exemplary embodiment of the optical system 100, the immersion unit 102 has at least one of the following features: (i) at least one first immersion device in solid form, and (ii) at least one second immersion device in liquid form. The first immersion device in solid form includes, for example, silicon, germanium, zinc sulfide, chalcogenides, AsSe and/or GeAsSe. For example, the immersion unit 102 is fully formed as first immersion device. In other words, the immersion unit 102 is provided completely in solid form. The second immersion device in liquid form includes, for example, water, an oil and/or glycerol. For example, the immersion unit 102 is fully formed as second immersion device. In other words, the immersion unit 102 is provided completely in liquid form.

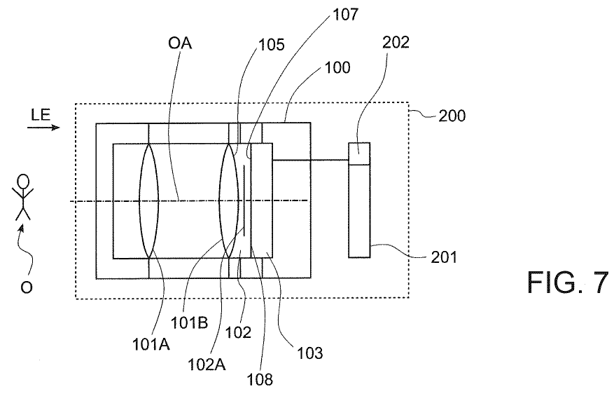

FIG. 7 shows a schematic representation of a further exemplary embodiment of the camera 200 for imaging an object O. The exemplary embodiment of FIG. 7 is based on the exemplary embodiment of FIG. 4. Therefore, reference is made to the comments above, which also apply here. Identical components are provided with identical reference signs. In contrast with the exemplary embodiment of FIG. 4, the exemplary embodiment of FIG. 7 provides for the immersion unit 102 to include at least one optical unit 102A. The optical unit 102A has at least one of the following features: (i) the optical unit 102A is plane-parallel; (ii) a refractive index of the optical unit 102A is larger than a refractive index of a medium adjacent to the immersion unit 102 at the object side; (iii) the optical unit 102A is configured to filter light; (iv) the optical unit 102A is configured to filter infrared light. Explicit reference is made to the fact that the disclosure is not restricted to the aforementioned exemplary embodiments of the optical unit 102A. Rather, any optical unit suitable for the disclosure can be used as optical unit 102A. For example, the optical unit 102A may be curved and/or formed as a microlens. The aforementioned medium is, for example, air or the second lens unit 101B.

The camera 200 and the optical system 100 according to FIGS. 4 to 7 also ensure that a larger numerical aperture NA of the optical system according to the disclosure can be achieved due to the arrangement of the immersion unit 102 at the sensor unit 103. A larger numerical aperture NA of said optical system 100 in contrast to the prior art leads to a smaller F-number of the optical system 100 according to an aspect of the disclosure in comparison with the prior art. It is therefore possible to achieve a smaller resolution limit compared to the prior art (see equation [3]). Due to the larger numerical aperture of said optical system 100 in comparison with the prior art, a higher resolution of said optical system 100 in comparison with the prior art can accordingly also be achieved (see equation [5]). Further, said optical system 100 ensures that the numerical aperture in the region of the sensor unit 103 is larger than the numerical aperture in the object-side region of the immersion unit 102.

The disclosure results in a high resolution of the optical system according to the disclosure at the same time as a smaller size of the sensor compared to the prior art. This leads, on the one hand, to lower costs with regard to the sensor (since the costs of a sensor usually increase with the size of the sensor) and, on the other hand, to devices including the optical system according to the disclosure being able to be configured smaller than in the prior art.

The features of the disclosure that are disclosed in the present description, in the drawings and in the claims may be essential for the implementation of the disclosure in its various exemplary embodiments both individually and in any desired combinations. The disclosure is not restricted to the described exemplary embodiments. It can be varied within the scope of the claims and taking into account the knowledge of those skilled in the relevant art.

### LIST OF REFERENCE NUMERALS

100 Optical system
101 Lens unit
101A First lens unit
101B Second lens unit
102 Immersion unit
102A Optical unit of the immersion unit
103 Sensor unit
104 Absorption unit
105 First surface of the immersion unit
106 First surface of the lens unit
107 Second surface of the immersion unit
108 Detection surface of the sensor unit
109 First surface of the absorption unit
110 Second surface of the absorption unit
200 Camera
201 Display unit
202 Processor unit
IA Immersion unit distance
AA Absorption unit distance
LE Light incidence direction
O Object
OA Optical axis

1. An optical system for a camera for imaging an object, the optical system comprising:
at least one sensor unit;
at least one first lens unit;
at least one second lens unit;
at least one immersion unit having a refractive index,
wherein:
the optical system has a light incidence direction,
when viewed in the light incidence direction, first the at least one first lens unit, then the at least one second lens unit, then the at least one immersion unit and then the at least one sensor unit are arranged along an optical axis of the optical system,
the at least one immersion unit is arranged between the at least one second lens unit and the at least one sensor unit,
the at least one immersion unit is arranged at the at least one second lens unit,
the at least one immersion unit is arranged at the at least one sensor unit, and
the at least one second lens unit and the at least one immersion unit together have positive refractive power.

2. The optical system according to claim 1, wherein the at least one immersion unit touches the at least one sensor unit.

3. The optical system according to claim 1, wherein the optical system has at least one of the following features:
(i) the at least one immersion unit and the at least one sensor unit are arranged at a distance from one another;
(ii) the at least one immersion unit is at an immersion unit distance from the at least one sensor unit, wherein the following applies to the immersion unit distance:
$$0 < IA \leq {λ}_{I} ,$$
wherein IA is the immersion unit distance and λ_{I} is a wavelength of light incident into the optical system.

4. The optical system according to claim 1, further comprising at least one absorption unit is arranged between the at least one immersion unit and the at least one sensor unit.

5. The optical system according to claim 4, wherein the optical system has at least one of the following features:
(i) the at least one absorption unit is configured to filter infrared light,
(ii) the at least one absorption unit is configured to generate infrared light,
(iii) the at least one absorption unit and the at least one sensor unit are arranged at a distance from one another, and
(iv) the at least one absorption unit is arranged at an absorption unit distance from the at least one sensor unit, wherein the following applies to the absorption unit distance:
$$0 < AA \leq {λ}_{A} ,$$
wherein AA is the absorption unit distance and λ_{A} is a wavelength of light incident into the optical system.

6. An optical system according to claim 1, wherein the at least one immersion unit has at least one of the following features:
(i) at least one first immersion device in solid form, and
(ii) at least one second immersion device in liquid form.

7. The optical system according to claim 1, wherein the at least one immersion unit has at least one optical unit, wherein the at least one optical unit has at least one of the following features:
(i) the at least one optical unit is plane-parallel,
(ii) a refractive index of the at least one optical unit is larger than a refractive index of a medium adjacent to the at least one immersion unit at the object side,
(iii) the at least one optical unit is configured to filter light, and
(iv) the at least one optical unit is configured to filter infrared light.

8. The optical system as claimed in claim 1, wherein the optical system has one of the following features:
(i) the refractive index of the at least one immersion unit is larger than a refractive index of a medium adjacent to the at least one immersion unit at the object side, and
(ii) the refractive index is different from or identical to the refractive index of a medium adjacent to the at least one immersion unit at the object side, with the deviation being ±0.01 or ±0.02.

9. A camera for imaging an object, comprising the optical system according to claim 1.

10. The camera according to claim 9, wherein the camera is a thermal imaging camera.
